(19) United States
(12) Patent Application Publication
(10) Pub. No.: US 2024/0304967 A1
(43) Pub. Date: Sep. 12, 2024

(54) APPARATUS AND SYSTEM FOR SPLITTING AND/OR COMBINING SIGNALS

(71) Applicant: Nokia Shanghai Bell Co., Ltd, Shanghai (CN)

(72) Inventors: Denis TUAU, Trignac (FR); Jose ENRIQUEZ GONZALEZ, Saint Nazaire (FR); Gildas BENGLOAN, Nantes (FR)

(73) Assignee: Nokia Shanghai Bell Co., Ltd, Shanghai (CN)

(21) Appl. No.: 18/442,311

(22) Filed: Feb. 15, 2024

(30) Foreign Application Priority Data
Feb. 16, 2023 (FI) 20235179

(51) Int. Cl. H01P 1/17; H01P 1/161

(52) U.S. Cl. CPC H01P 1/17; H01P 1/161

(57) ABSTRACT

An apparatus comprising:
a first waveguide port configured to support first signals having a first polarisation state;
a second waveguide port configured to support second signals having a second polarisation state orthogonal to the first polarisation state;
a third waveguide port configured to support combined signals comprising a first signal component having the first polarisation state and a second signal component having the second polarisation state;
a waveguide structure, disposed between the first waveguide port, the second waveguide port and the third waveguide port, configured to:
split a combined signal received via the third waveguide port into first and second signal components and to provide the first signal component to the first waveguide port and the second signal component to the second waveguide port,
and/or
combine a first signal received via the first waveguide port and a second signal received via the second waveguide port into a combined signal and to provide the combined signal to the third waveguide port;
wherein an end portion of the first waveguide port, adjacent the waveguide structure, comprises, at a first side, a first curved portion having a first radius of curvature, r1, and, at a second side, a second curved portion having a second, different radius of curvature, r2.

### TECHNOLOGICAL FIELD

Examples of the disclosure relate to an apparatus and system for splitting and/or combining signals. Some relate to an apparatus and system for splitting and/or combining signals in an orthomode transducer.

### BACKGROUND

It is desirable to have an apparatus that is configured to efficiently and effectively split and combine signals.

However, apparatus configured to split and combine signals can be complicated and/or large.

### BRIEF SUMMARY

According to various, but not necessarily all, embodiments, there is provided an apparatus comprising:
a first waveguide port configured to support first signals having a first polarisation state;
a second waveguide port configured to support second signals having a second polarisation state orthogonal to the first polarisation state;
a third waveguide port configured to support combined signals comprising a first signal component having the first polarisation state and a second signal component having the second polarisation state;
a waveguide structure, disposed between the first waveguide port, the second waveguide port and the third waveguide port, configured to:
split a combined signal received via the third waveguide port into first and second signal components and to provide the first signal component to the first waveguide port and the second signal component to the second waveguide port,
and/or
combine a first signal received via the first waveguide port and a second signal received via the second waveguide port into a combined signal and to provide the combined signal to the third waveguide port;
wherein an end portion of the first waveguide port, adjacent the waveguide structure, comprises, at a first side, a first curved portion having a first radius of curvature, r1, and, at a second side, a second curved portion having a second, different radius of curvature, r2.

In some examples, r₁ is greater than r₂.

In some examples,

$$\frac{λ}{8} < \frac{{r}_{1}}{{r}_{2}} < \frac{λ}{4} ,$$

wherein λ is the free space wavelength at the center of the frequency band.

In some examples, the first waveguide port is substantially rectangular and has a height t₁, wherein the waveguide structure comprises a portion having a height t₂ adjacent the end portion of the first waveguide portion, wherein t₁ is greater than t₂.

In some examples, the waveguide structure comprises a first curved portion having a radius of curvature r₃ and a second curved portion having a radius of curvature r₃, the first curved portion located above the second curved portion and the first and second curved portions adjacent the first curved portion of the first waveguide port.

In some examples, r₃ is approximately 20% more than r₁.

In some examples, the first curved portion has a height greater than t₁ and the second curved portion has a height greater than t₁.

In some examples, the first and second curved portions are separated by a height of t₂.

In some examples, the waveguide structure comprises a first substantially square outwardly extending portion at an upper surface and a second substantially square outwardly extending portion at a lower surface, wherein the first and second substantially square outwardly extending portions have substantially the same dimensions and are located substantially opposite each other and wherein the center of the first and second substantially square outwardly extending portions is located on a center line of the second and third waveguide ports and is offset from a center line of the first waveguide port by a distance Δ.

In some examples, the side length L_{E} of the first and second substantially square outwardly extending portions is approximately λ/4, wherein λ is the free space wavelength at the center of the frequency band.

In some examples, the distance Δ is less than λ/4, wherein λ is the free space wavelength at the center of the frequency band.

In some examples, the third waveguide port is substantially rectangular and has a height H_{C} and a distance, Hₑ, between the first and second substantially square outwardly extending portions is approximately 1.2 times H_{C}.

In some examples, the apparatus comprises a waveguide junction.

According to various, but not necessarily all, embodiments there is provided an Orthomode Transducer, OMT, comprising an apparatus as described herein

According to various, but not necessarily all, embodiments there is provided an antenna system comprising an apparatus as described herein and/or an OMT as described herein.

According to various, but not necessarily all, examples there is provided examples as claimed in the appended claims.

The description of any means suitable for performing a function and/or of any feature, and/or component, and/or structure, and/or device, and/or apparatus configured to perform a function should additionally be considered to disclose a method comprising performing the function.

For example, description of an apparatus configured to perform at least one function should also be considered to describe a method comprising performing the at least one function.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

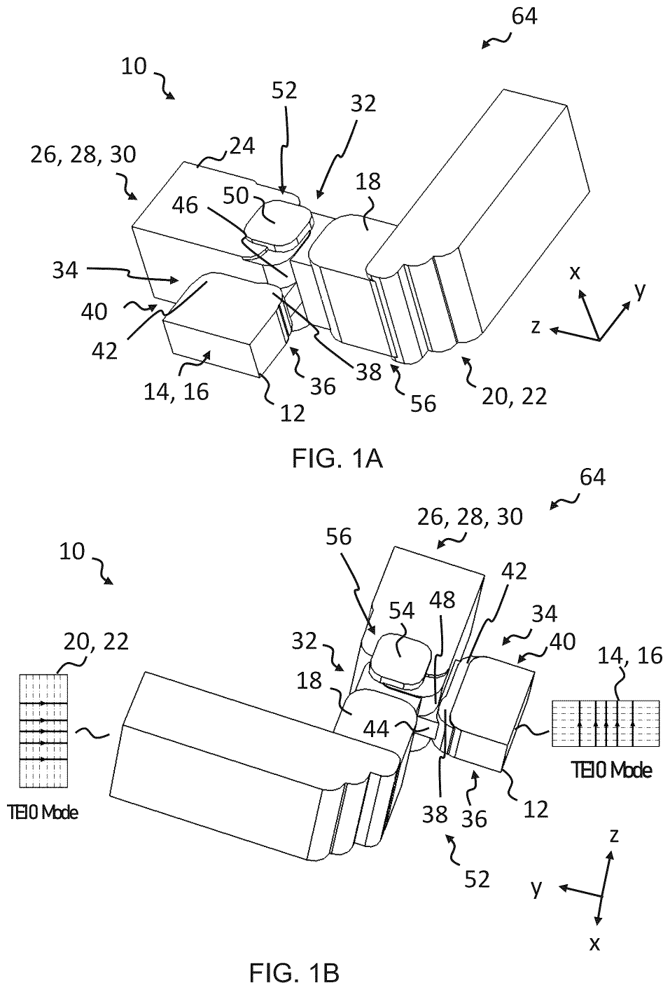

FIG. 1A shows an example of the subject matter described herein;

FIG. 1B shows another example of the subject matter described herein;

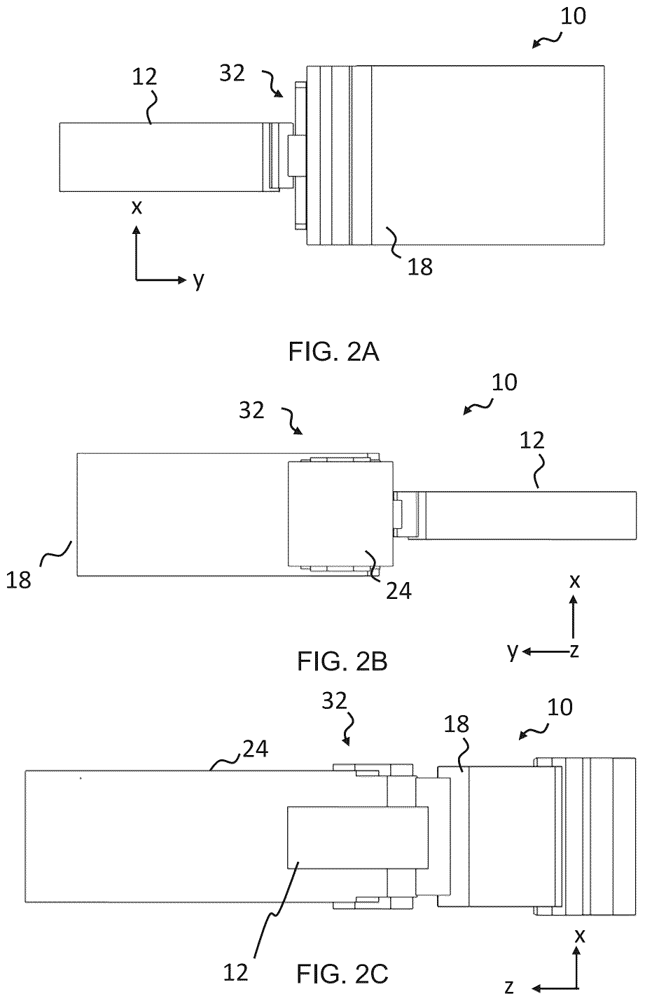

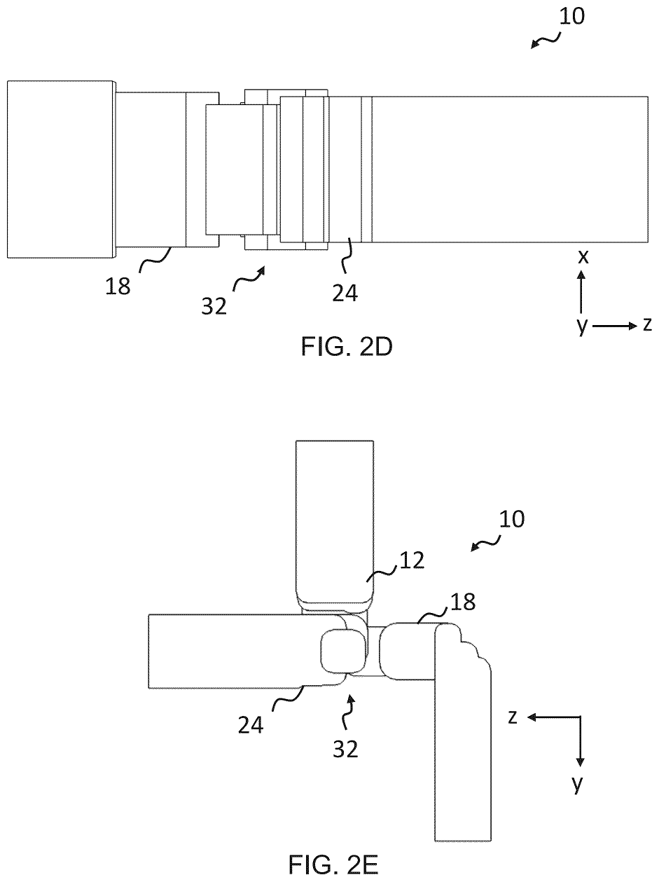

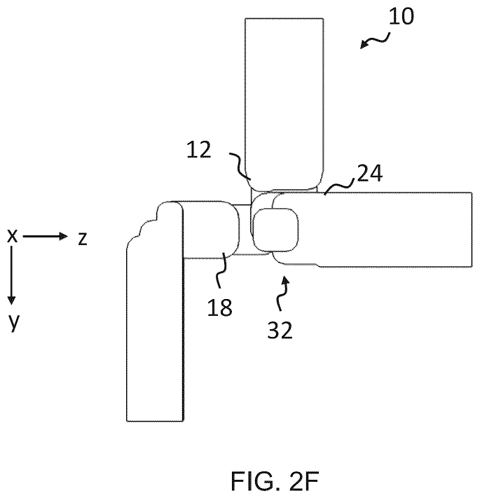

FIG. 2A shows another example of the subject matter described herein;

FIG. 2B shows another example of the subject matter described herein;

FIG. 2C shows another example of the subject matter described herein;

FIG. 2D shows another example of the subject matter described herein;

FIG. 2E shows another example of the subject matter described herein;

FIG. 2F shows another example of the subject matter described herein;

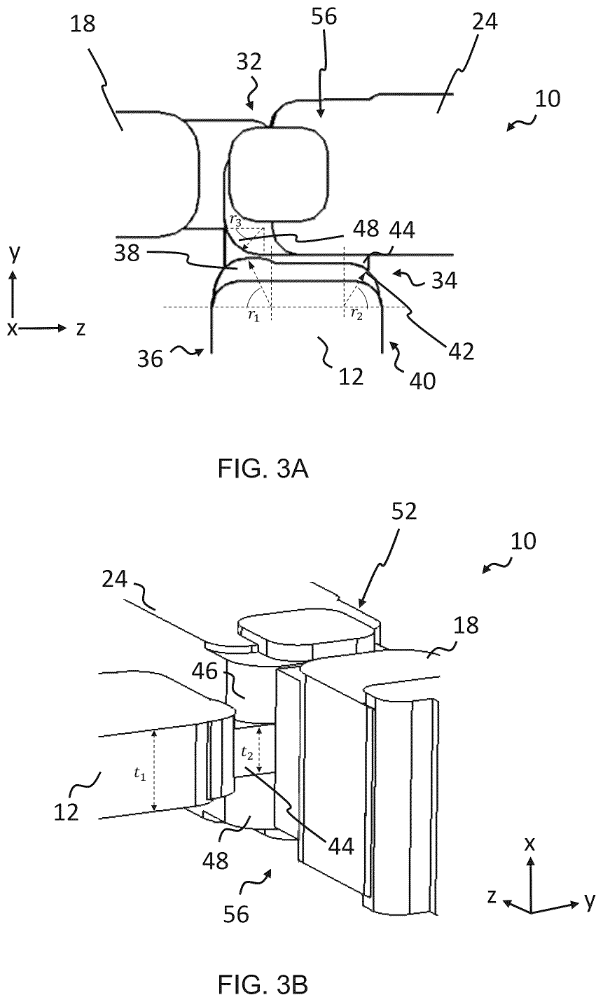

FIG. 3A shows another example of the subject matter described herein;

FIG. 3B shows another example of the subject matter described herein;

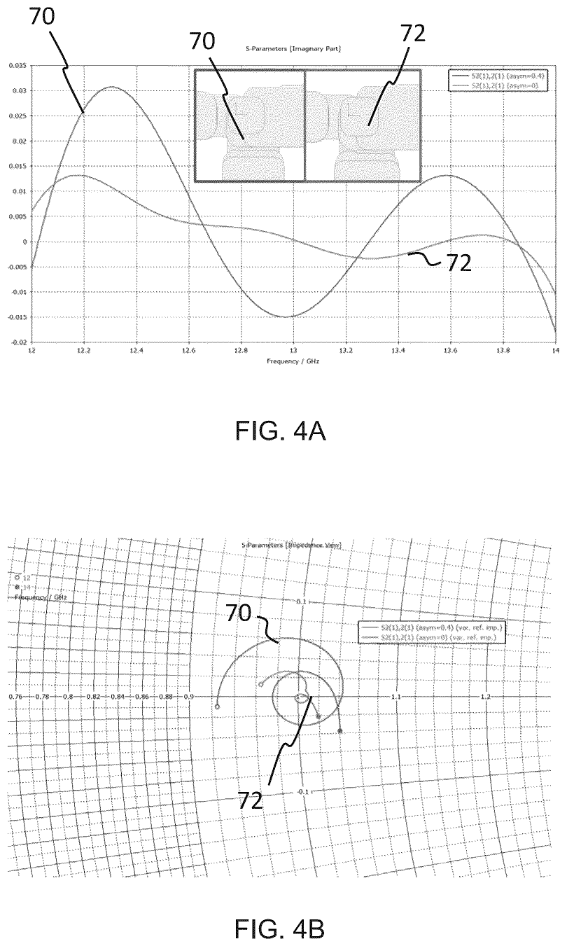

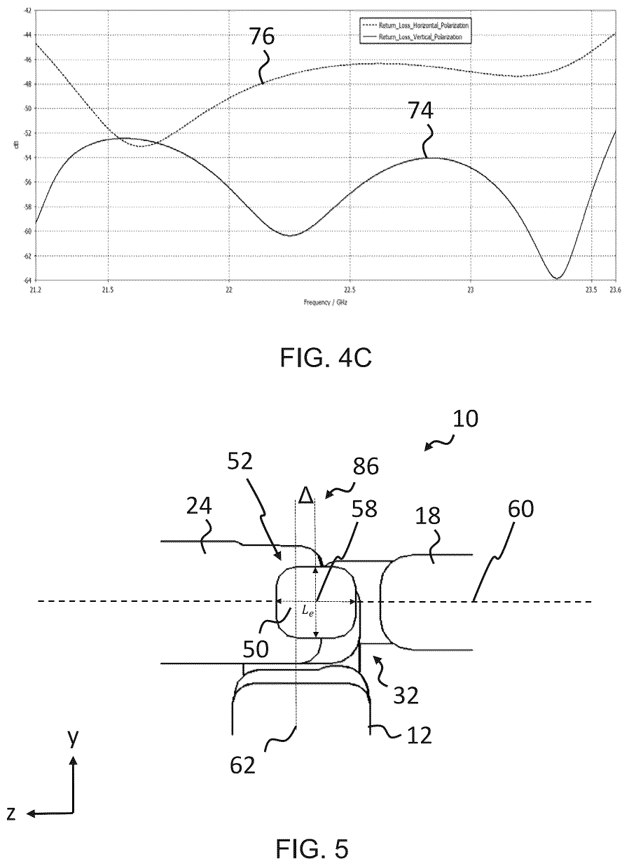

FIG. 4A shows another example of the subject matter described herein;

FIG. 4B shows another example of the subject matter described herein;

FIG. 4C shows another example of the subject matter described herein;

FIG. 5 shows another example of the subject matter described herein;

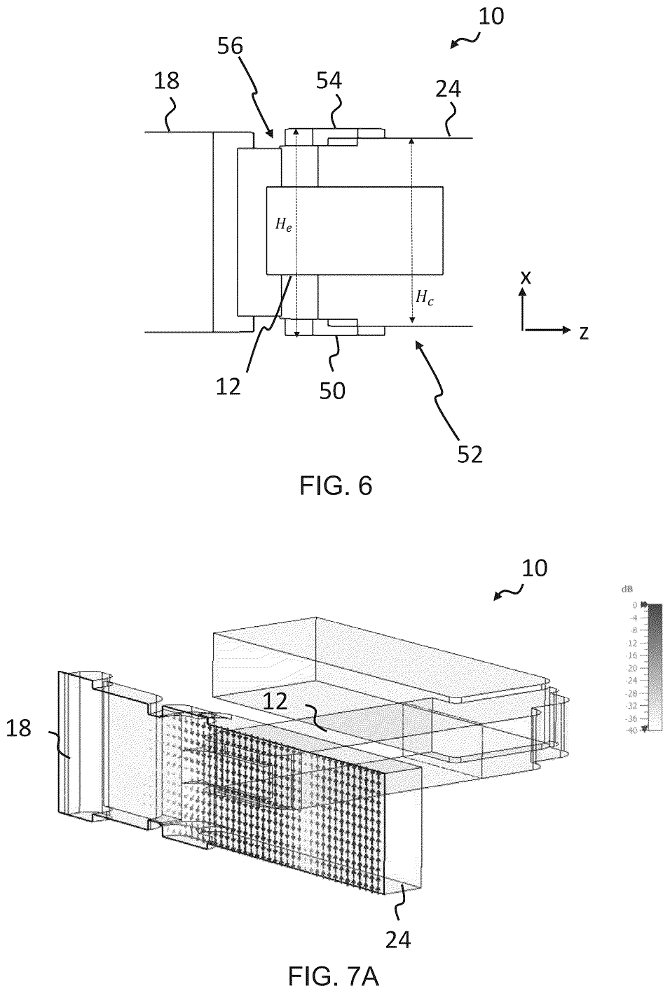

FIG. 6 shows another example of the subject matter described herein;

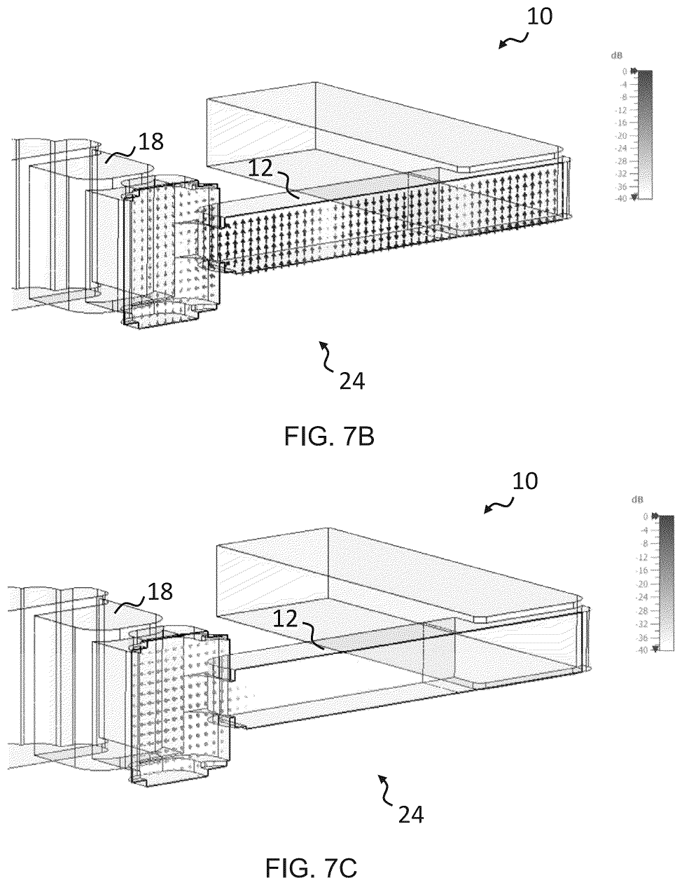

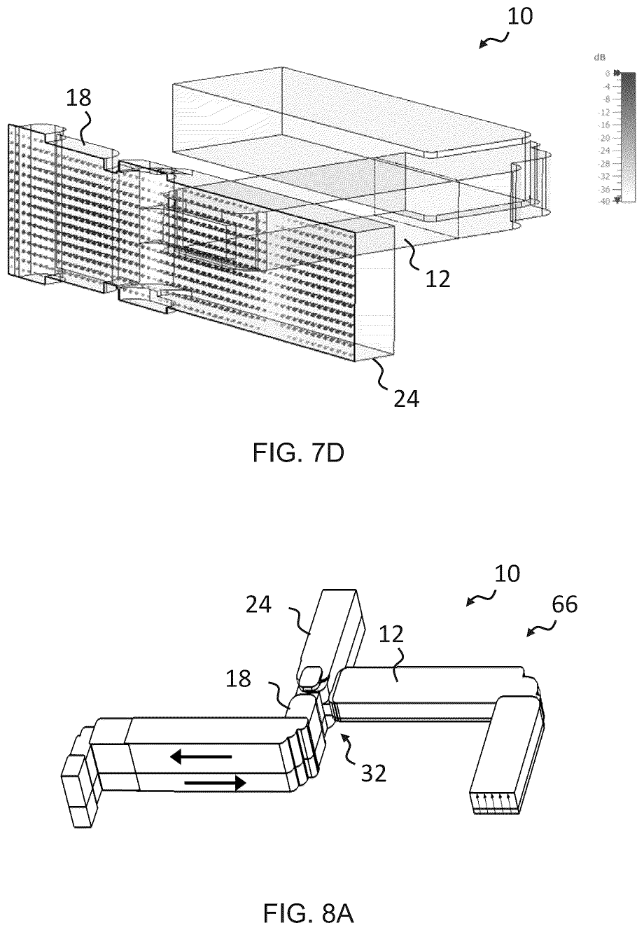

FIG. 7A shows another example of the subject matter described herein;

FIG. 7B shows another example of the subject matter described herein;

FIG. 7C shows another example of the subject matter described herein;

FIG. 7D shows another example of the subject matter described herein;

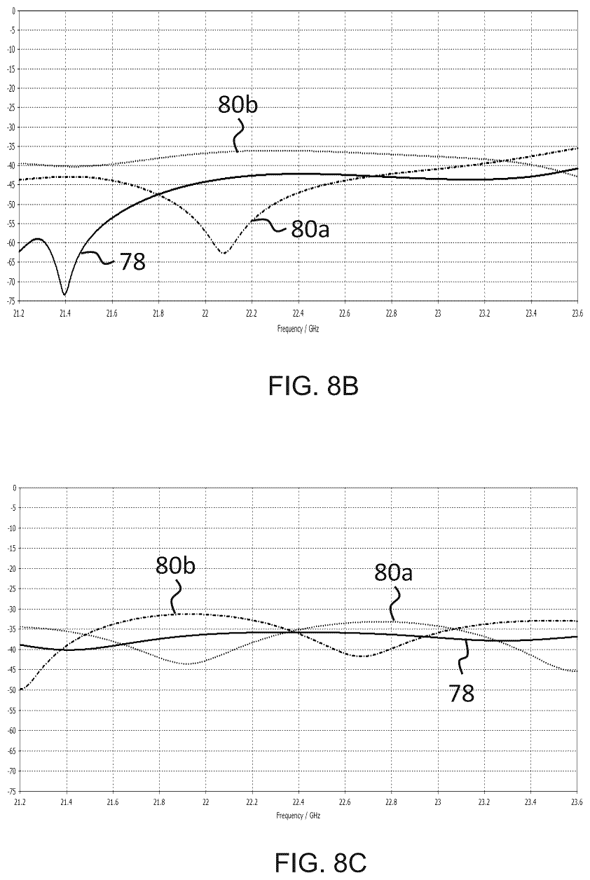

FIG. 8A shows another example of the subject matter described herein;

FIG. 8B shows another example of the subject matter described herein;

FIG. 8C shows another example of the subject matter described herein;

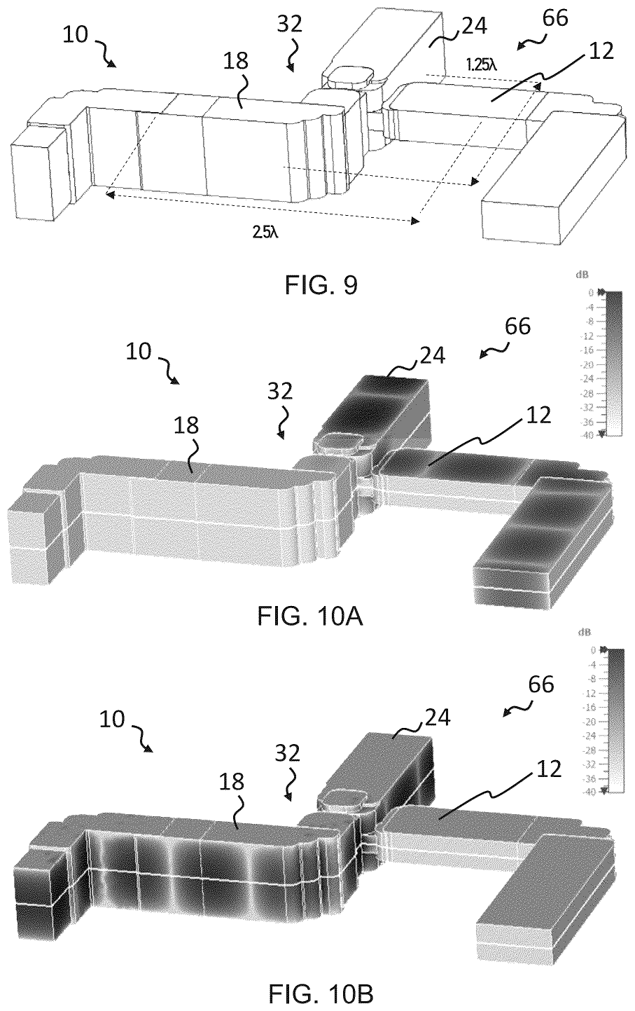

FIG. 9 shows another example of the subject matter described herein;

FIG. 10A shows another example of the subject matter described herein;

FIG. 10B shows another example of the subject matter described herein;

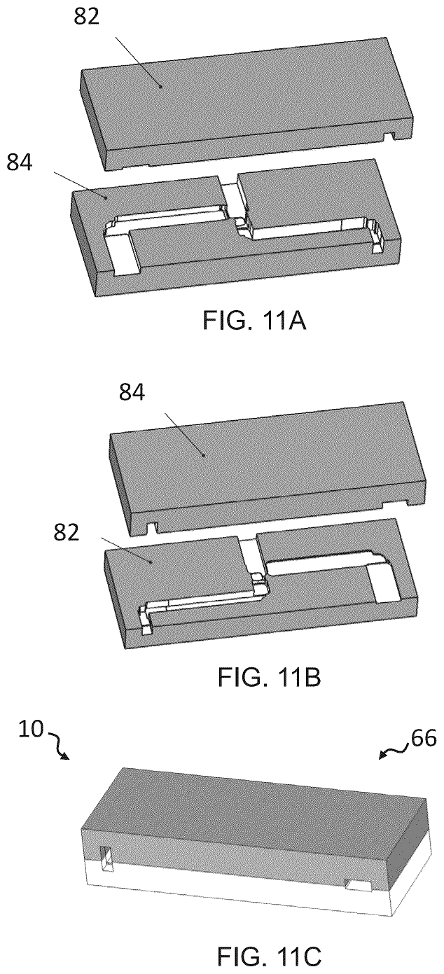

FIG. 11A shows another example of the subject matter described herein;

FIG. 11B shows another example of the subject matter described herein; and

FIG. 11C shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### DETAILED DESCRIPTION

The FIGS. illustrate examples of an apparatus 10 configured to split and/or combine signals, for example electromagnetic signals such as radio frequency signals.

In some examples, the apparatus 10 is configured to operate in any suitable frequency band or bands. For example, the apparatus 10 can be configured to operate in any suitable frequency band or bands in the range 6 GHz to 80 GHz.

In examples, the apparatus 10 comprises:
a first waveguide port 12 configured to support first signals 14 having a first polarisation state 16;
a second waveguide port 18 configured to support second signals 20 having a second polarisation state 22 orthogonal to the first polarisation state 16;
a third waveguide port 24 configured to support combined signals 26 comprising a first signal component 28 having the first polarisation state 16 and a second signal component 30 having the second polarisation state 22;
a waveguide structure 32, disposed between the first waveguide port 12, the second waveguide port 18 and the third waveguide port 24, configured to:
split a combined signal 26 received via the third waveguide port 24 into first and second signal components 28, 30 and to provide the first signal component 28 to the first waveguide port 12 and the second signal component 30 to the second waveguide port 18,
and/or
combine a first signal 14 received via the first waveguide port 12 and a second signal 20 received via the second waveguide port 18 into a combined signal 26 and to provide the combined signal 26 to the third waveguide port 24;
wherein an end portion 34 of the first waveguide port 12, adjacent the waveguide structure 32, comprises, at a first side 36, a first curved portion 38 having a first radius of curvature, r1, and, at a second side 40, a second curved portion 42 having a second, different radius of curvature, r2.

In some examples, the apparatus 10 comprises a waveguide junction 64.

The FIGS. generally represent the apparatus 10 and/or the features of the apparatus 10 as three-dimensional hollow structures and/or voids. Accordingly, various FIGS. show the three-dimensional hollow structure and/or voids comprising the features described.

The outlines in the FIGS. can be considered to show the internal waveguides.

The description of a three-dimensional hollow structure and/or void should also be considered a description of the associated/corresponding surface or surfaces and/or component or components configured to provide the three-dimensional hollow structure. For example, a description of a particular feature in a three-dimensional hollow structure and/or void should be considered to also disclose the structure and/or surfaces of the associated/corresponding component or components configured to provide the particular shape and/or feature of the three-dimensional hollow structure and/or void.

FIG. 1A shows a perspective view of an example of an apparatus 10 according to the present disclosure.

FIG. 1A shows an upper surface 52 of the apparatus 10, wherein upwards can be considered to be in the positive ‘x’ direction and downwards can be considered to be in the negative ‘x’ direction as indicated in the associated axes also shown in the example of FIG. 1 and other FIGS.

As discussed above, the FIGS. generally show the apparatus 10 and/or features of the apparatus 10 as three-dimensional hollow structures and/or voids. Accordingly, an upper surface 52 of the apparatus 10 can be considered an uppermost and/or top part of the three-dimensional hollow structure and/or void.

Similarly, an upper surface 52 can be considered a surface of the component or components configured to provide the upper surface 52 of the apparatus 10.

In examples, an upper surface 52 can be considered an upper portion and/or profile. Similarly, a lower surface 56 can be considered a lower portion and/or profile.

Various features referenced in the discussion of FIG. 1A can be found in the other FIGS. Furthermore, during the discussion of FIG. 1A, reference will be made to other FIGS. by way of example.

In the example of FIG. 1, the apparatus 10 is a waveguide component, such as a waveguide junction 64 for/configured to split and/or combine signals, for example electromagnetic signals in the range 6 GHz to 80 GHz.

The apparatus 10 comprises a first waveguide port 12, a second waveguide port 18, and a third waveguide port 24. The first waveguide port 12 is substantially at right angles to the second waveguide port 18 and third waveguide port 24. In examples, the apparatus 10 can be considered a T-junction.

The apparatus 10 also comprises a waveguide structure 32 that is disposed between the first waveguide port 12, the second waveguide port 18, and the third waveguide port 24.

In examples, the apparatus 10 is symmetric about a central z-y plane according to the associated axes in the FIGS.

The first waveguide port 12 is configured to support first signals 14 having a first polarisation state 16. In examples, the first waveguide port 12 serves as an input/output, I/O, configured to support signals having a first polarisation state 16.

The first polarisation state 16 can be any suitable polarisation state. For example, the first polarisation state 16 can be any suitable polarisation state having a corresponding orthogonal polarisation state. For example, the first polarisation state 16 can be a vertical polarisation state and the first waveguide port 12 can be configured to support vertically polarised signals.

The first waveguide port 12 can be configured in any suitable way to support first signals 14 having a first polarisation state 16. For example, the first waveguide port 12 can have any suitable shape, size and/or form to support first signals 14 having a first polarisation state 16. In examples, the first waveguide port 12 can be dimensioned to support first signals 14 having a first polarisation state 16.

The first waveguide port 12 can be a substantially rectangular waveguide.

Supporting a signal, such as a first signal 14 having a first polarisation state 16, can be considered allowing a signal to pass and/or propagate. For example, the first waveguide port 12 is configured to support first signals 14 having a first polarisation state 16 and therefore first signals 14 having the first polarisation state 16 can readily pass into and propagate along the first waveguide port 12.

The second waveguide port 18 is configured to support second signals 20 having a second polarisation state 22. In examples, the second waveguide port 18 serves as an input/output, I/O, configured to support signals having a second polarisation state 22

The second polarisation state 22 can be any suitable polarisation state. For example, the second polarisation state 22 can be any suitable polarisation state orthogonal to the first polarisation state 16. For example, the second polarisation state 22 can be a horizontal polarisation state and the second waveguide port 18 can be configured to support horizontally polarised signals.

The second waveguide port 18 can be configured in any suitable way to support second signals 20 having a second polarisation state 22. For example, the second waveguide port 18 can have any suitable shape, size and/or form to support second signals 20 having a second polarisation state 22. In examples, the second waveguide port 18 can be dimensioned to support second signals 20 having a second polarisation state 22.

The second waveguide port 18 can be a substantially rectangular waveguide.

In the example of FIG. 1A, the second waveguide port 18 leads to and/or includes a waveguide section having a substantially 90-degree bend/turn/elbow. However, in examples, the waveguide leading from the second waveguide port 18 can be configured differently and can have any suitable configuration.

The third waveguide port 24 is configured to support combined signals 26 comprising a first signal component 28 having the first polarisation state 16 and a second signal component 30 having the second polarisation state 22. In examples, the third waveguide port 24 serves as an input/output, I/O, configured to support combined signals 26 comprising a first signal component 28 having the first polarisation state 16 and a second signal component 30 having the second polarisation state 22.

For example, the third waveguide port 24 can be configured to support both and/or combined orthogonal signals, such as vertically and horizontally polarised signals. The third waveguide port 24 can be configured in any suitable way to support combined signals 26 comprising a first signal component 28 having the first polarisation state 16 and a second signal component 30 having the second polarisation state 22. For example, the third waveguide port 24 can have any suitable shape, size and/or form to support combined signals 26 comprising a first signal component 28 having the first polarisation state 16 and a second signal component 30 having the second polarisation state 22. In examples, the third waveguide port 18 can be dimensioned to support combined signals 26 comprising a first signal component 28 having the first polarisation state 16 and a second signal component 30 having the second polarisation state 22.

The third waveguide port 24 can be a substantially square or circular waveguide.

The first waveguide port 12 can be configured to support the first signals 14 having the first polarisation state 16 and not the second signals 20 having the second polarisation state 22.

The second waveguide port 18 can be configured to support the second signals 20 having the second polarisation state 22 and not the first signals 14 having the first polarisation state 16.

The first waveguide port 12 can be a rectangular waveguide supporting a TE10 mode and the propagation of first signals 14 having a vertical polarisation and/or the second waveguide port 18 can be a rectangular waveguide supporting a TE10 mode and the propagation of second signals 20 having a horizontal polarisation. See, for example, FIG. 1B.

FIG. 1B shows a different perspective view of the example illustrated in FIG. 1A.

FIG. 1B shows a lower surface 56 of the apparatus 10. As discussed above, the FIGS. generally show the apparatus 10 and/or features of the apparatus 10 as three-dimensional hollow structures and/or voids. Accordingly, a lower surface 56 of the apparatus 10 can be considered a lowermost and/or bottom part of the three-dimensional hollow structure and/or void.

Similarly, a lower surface 56 can be considered a bottom surface of the component or components configured to provide the three-dimensional hollow structure and/or void.

As indicated in the example of FIG. 1B, the first waveguide port supports a TE10 mode and the propagation of first signals 14 having a vertical polarisation and the supports a TE10 mode and the propagation of second signals 20 having a horizontal polarisation.

Returning to the discussion of FIG. 1A, the waveguide structure 32 is disposed between the first waveguide port 12, the second waveguide port 18, and the third waveguide port 24 and is configured to:
split a combined signal 26 received via the third waveguide port 24 into first and second signal components 28, 30 and to provide the first signal component 28 to the first waveguide port 12 and the second signal component 30 to the second waveguide port 18, and/or
combine a first signal 14 received via the first waveguide port 12 and a second signal 20 received via the second waveguide port 18 into a combined signal 26 and to provide the combined signal 26 to the third waveguide port 24.

Accordingly, in examples, at least a portion of the first signal 14 and at least a portion of the second signal 20 can be combined to form the combined signal 26.

Similarly, in examples, at least a portion of the first signal component 28 can form the first signal 14 and/or at least a portion of the second signal component 30 can form the second signal 20.

The waveguide structure 32 can be configured in any suitable way to split a combined signal 26 received via the third waveguide port 24 into first and second signal components 28, 30 and to provide the first signal component 28 to the first waveguide port 12 and the second signal component 30 to the second waveguide port 18, and/or
combine a first signal 14 received via the first waveguide port 12 and a second signal 20 received via the second waveguide port 18 into a combined signal 26 and to provide the combined signal 26 to the third waveguide port 24.

For example, the waveguide structure 32 can have any suitable shape, size and/or form to split a combined signal 26 received via the third waveguide port 24 into first and second signal components 28, 30 and to provide the first signal component 28 to the first waveguide port 12 and the second signal component 30 to the second waveguide port 18, and/or
combine a first signal 14 received via the first waveguide port 12 and a second signal 20 received via the second waveguide port 18 into a combined signal 26 and to provide the combined signal 26 to the third waveguide port 24.

In examples, the waveguide structure 32 can comprise a portion of the first waveguide port 12, and/or a portion of the second waveguide port 18, and/or a portion of the third waveguide port 24.

In examples, the waveguide structure 32 can have any suitable shape, size and/or form to allow the apparatus 10 function as at least part of an orthomode transducer (OMT).

In examples, an end portion 34 of the first waveguide port 12, adjacent the waveguide structure 32, comprises, at a first side 36, a first curved portion 38 having a first radius of curvature, r1, and, at a second side 40, a second curved portion 48 having a second, different radius of curvature, r2.

An end portion 34 of the first waveguide port 12 can comprise any suitable portion of the first waveguide port 12 adjacent the waveguide structure 32.

In examples, the end portion 34 of the first waveguide port 12 can be considered proximate, and/or next-to, and/or adjoining and/or beside the waveguide structure 32. With reference to, for example, the example of FIG. 1A, the waveguide structure 32 can be considered to be adjacent the end portion 34 of the first waveguide port 12 in the positive y direction.

The first and second sides 36, 40 of the end portion 34 of the first waveguide port 12 can be different sides of the end portion 34 in the +/−z direction illustrated in, for example, FIG. 1A.

In the example of FIG. 1A, the first side 36 of the end portion 34 of the first waveguide port 12 is to the left of the FIG. and the second side 40 of the end portion 34 of the first waveguide port 12 is to the right of the FIG. The first and second sides 36, 40 of the end portion 34 of the first waveguide port 12 are swapped in the view shown in the example of FIG. 1B.

In examples, the end portion 34 of the first waveguide port 12 can be considered to comprise asymmetrical rounded corners.

By way of example, reference is made to the example of FIG. 3A.

FIG. 3A shows a plan view of the apparatus 10 in the example of FIG. 1A. The view shown in the example of FIG. 3A is of the lower surface 56 of the apparatus 10, and provides a clearer view of the end portion 34 of the first waveguide port 12.

In the example of FIG. 3A the end portion 34 comprises, at a first side 36 (left side in FIG. 3A) a first curved portion 38 having a first radius of curvature, r1, and, at a second side 40 (right side in FIG. 3A) a second curved portion 42 having a second, different radius of curvature, r2.

In examples, the dimensions are selected to spread properly the energy of the TE₁₀ dominant mode and improve the radio frequency (RF) matching impedance over a broadband frequency domain.

In examples, the end portion 34 of the first waveguide port 12 can be considered to comprise a wide band asymmetrical bend to convey the, for example, linear vertical polarization perpendicular to the horizontal polarization, into the third waveguide port 24 (which is, in some examples, square shaped).

The new polarizing device bending shape provides a smooth transition of the electrical fields (E-field) keeping in a large frequency band the purity phase difference of 90° related with the orthogonal horizontal polarization so that the value of 90 degrees phase polarisation remains unchanged/stabilized/steadied.

The asymmetrical broadband bend acts as a wide band short circuit through the innovative retained geometric shapes. In examples, adaptative steps are progressively added to the asymmetrical bend to match (remove) the impedance imaginary part to improve the return loss and isolation performances of the, for example, vertical polarization over/related to horizontal polarisation and vice versa.

The first and second curved portions 38, 42 can have any suitable radii of curvature.

In some, but not necessarily all, examples r1 is greater than r2.

In some examples, the sizes of the r1 and r2 keep the relationship

$$\frac{λ}{8} < \frac{{r}_{1}}{{r}_{2}} < \frac{λ}{4}$$

Where λ is the free space wavelength (in millimeters) at the center of the frequency band that the apparatus 10 is configured to operate at.

For example, if the apparatus 10 is configured to operate in the frequency band 12 GHz to 14 GHz, the central frequency is 13 GHz and λ is 23.5 mm. In such an example, λ/4 and λ/8 vary from 2.88 m to 5.77 mm defining the possible r1 and r2 values according to the relationship.

For example, r1=3.3 mm and r2=1.1 mm satisfies the relationship in such an example.

Accordingly, in examples, the first waveguide port 12, for example vertical polarisation waveguide port, integrates two asymmetrical bends, as shown in FIG. 3A for example, to create two frequency spaced resonant frequencies over the operation bandwidth.

FIGS. 4A and 4B illustrate impedance matching performance for the apparatus 10 with and without the asymmetric curved portions 38, 42 at the end portion 34 of the first waveguide port 12. FIG. 4A is a linear plot and FIG. 4B is a Smith Chart.

In the examples of FIGS. 4A and 4B, the plotted lines show simulated impedance imaginary part. Line 70 is without the asymmetric curved portions 38, 42 at the end portion 34 of the first waveguide port 12 and line 72 is with the asymmetric curved portions 38, 42.

As can be seen from FIGS. 4A and 4B, the disclosed apparatus 10 can remove the unwanted imaginary part of the impedance over a broad frequency band (for example 12 GHz-14 GHz, bandwidth of 16%) with two spaced resonant frequencies, on the FIG. 4A, 12.3 GHz and 13.6 GHz.

Considering FIG. 4B, the Smith Chart locus, the impedance is correctly closer to the center (imaginary part close to zero, perfect matching).

Furthermore, examples of the disclosure provide for enhanced return loss values.

FIG. 4C shows simulated return loss for signals having a first polarisation state 16 (line 74) and signals having a second polarisation state 22 (line 76). In the illustrated example, the first polarisation state 16 is vertical and the second polarisation state 22 is horizontal.

As can be seen from the example of FIG. 4C, the return loss value is enhanced compared to earlier solutions up to better than 30 dB over 30% of bandwidth on both polarizations.

Returning to the example of FIG. 1A, in some examples, the first waveguide port 12 is substantially rectangular and has a height t1, wherein the waveguide structure 32 comprises a portion 44 having a height t2 adjacent the end portion 34 of the first waveguide portion 12, wherein t1 is greater than t2.

As used herein, the height of a feature, such as the first waveguide port 12, can be considered the extent of the feature in the x-direction according to the associated axes in the FIGS.

By way of example, reference is made to the examples of FIGS. 3A and 3B.

FIG. 3B shows another perspective view of the apparatus 10 of the example of FIG. 1A. In the example of FIG. 3B, the upper surface 52 of the apparatus 10 is visible.

In the example of FIG. 3A, the portion 44 adjacent the end portion 34 of the first waveguide port 12 can be seen.

The portion 44 can be considered proximate, and/or next-to, and/or adjoining and/or beside the end portion 34 of the first waveguide port 12.

The portion 44 can be considered to be adjacent the end portion 34 of the first waveguide port 12 in the positive y direction.

In some examples, the portion 44 can be considered to be joined to and/or linked to the end portion 34 of the first waveguide port 12.

In some examples, the portion 44 can be considered to form part of the end portion 34 of the first waveguide port 12.

In some examples, the portion 44 can be considered a projection from the waveguide structure 32.

The portion 44 is, in examples, substantially rectangular in shape and has a narrower width than the first waveguide port 12, wherein the width of the portion 44 and the first waveguide port 12 can be considered extent in the z direction according to the associated axes in the FIGS.

As can be seen in the example of FIG. 3B, the portion 44 is located between the upper and lower surfaces of the first waveguide port 12. The portion 44 can be substantially symmetrically located with respect to the upper and lower surfaces of the first waveguide port 12. Accordingly, in examples, the portion 44 is located substantially centrally between upper and lower surfaces of the first waveguide portion 12.

As shown in the example of FIG. 3B the portion has a height t2 which is less than the height t1 of the first waveguide port 12.

In some examples, the height of the first waveguide port 12 and the portion 44 of the waveguide structure 32 follow the relationship t2=0.9*t1, where t1>3 mm.

This is advantageous as it allows, for example, a bigger section (at least 3 mm) of the polarizing divider which is significant compared to the wavelength and is greater than other solutions.

Returning to the example of FIG. 1A. In some, but not necessarily all, examples, the waveguide structure 32 comprises a first curved portion 46 having a radius of curvature r3 and a second curved portion 48 having a radius of curvature r3, the first curved portion 46 located above the second curved portion 48 and the first and second curved portions 46, 48 adjacent the first curved portion 38 of the first waveguide port 12.

The first curved portion 46 and second curved portion 48 of the waveguide structure 32 can be considered semicircles inscribed into the waveguide structure 32.

The first curved portion 46 and second curved portion 48 of the waveguide structure 32 can be considered curved elements, and/or curved sections, and/or rounded corners and so on.

By way of example, reference is again made to the examples of FIGS. 3A and 3B. As can be seen in, for example, the example of FIG. 3A, the second curved portion 48 (and first curved portion 46) of the waveguide structure 32 is adjacent the first curved portion 38 of the end portion 34 of the first waveguide port 12.

The first and second curved portions 46, 48 can be considered proximate, and/or next-to, and/or beside, and/or opposite the first curved portion 38 of the end portion 34 of the first waveguide port 12.

The first and second curved portions 46, 48 can be considered adjacent the first curved portion 38 of the end portion 34 of the first waveguide port 12 in the positive y direction in the associated axes in the FIGS.

In examples, the first and second curved portions 46, 48 are separated in the x direction, the first curved portion 46 being located above the second curved portion 48. This can be seen in the example of FIG. 3B.

The first and second curved portions 46, 48 are configured to counterbalance the exceeded imaginary part of mismatching impedances and can control the cross polarization exceeding energy.

In examples, the first and second curved portions 46, 48 of the waveguide structure 32 is well integrated with the two curved portions 38, 40 of the end portion 34 of the first waveguide port 12 on the same radio frequency plane.

The first and second curved portions 46, 48 of the waveguide structure 32 are configured to allow matching impedance steps to be done in the YZ plane, and the first and second curved portions 46, 48 of the waveguide structure 32 combine well with the energy transfer from the, for example, vertical polarization allowing at the same time a shortened length for the matching impedance and reducing the required dimension compared to earlier solutions.

The first and second curved portions 46, 48 of the waveguide structure 32 can have any suitable radius of curvature r3.

In some examples r3 is approximately 20% more than r1.

The first and second curved portions 46, 48 of the waveguide structure 32 can have any suitable dimensions. In examples, the first and second curved portions 46, 48 have substantially the same dimensions.

In some examples, the first curved portion 46 of the waveguide structure 32 has a height greater than t1 and the second curved portion 48 of the waveguide structure 32 has a height greater than t1.

In examples, the first and second curved portions 46, 48 are separated by the portion 44 of the waveguide structure 32. Accordingly, in some examples the first and second curved portions 46, 48 of the waveguide structure 32 are separated by a height of t2.

This can be seen in, for example, the example of FIG. 3B.

The first and second curved portions 46, 48 of the waveguide structure can be considered to sandwich the portion 44 of the waveguide structure. Accordingly, the portion 44 of the waveguide structure 32 can be considered to extend between the first and second curved portions 46, 48 of the waveguide structure towards the end portion 34 of the first waveguide port 12.

The first and second curved portions 46, 48 are, in examples, substantially symmetrical about the portion 44 of the waveguide structure 32.

FIG. 2A shows the apparatus 10 of the example of FIG. 1A viewed from the −z axis.

FIG. 2B shows the apparatus 10 of the example of FIG. 1A viewed from the +z axis.

FIG. 2C shows the apparatus 10 of the example of FIG. 1A viewed from the −y axis.

FIG. 2D shows the apparatus 10 of the example of FIG. 1A viewed from the +y axis.

FIG. 2E shows the apparatus 10 of the example of FIG. 1A viewed from the −x axis.

FIG. 2F shows the apparatus 10 of the example of FIG. 1A viewed from the +x axis.

In some, but not necessarily all, examples the waveguide structure 32 comprises a first substantially square outwardly extending portion 50 at an upper surface 52 and a second substantially square outwardly extending portion 54 at a lower surface 56, wherein the first and second substantially square outwardly extending portions 50, 54 have substantially the same dimensions and are located substantially opposite each other and wherein the center 58 of the first and second substantially square outwardly extending portions 50, 54 is located on a center line 60 of the second and third waveguide ports 18, 24 and is offset from a center line 62 of the first waveguide port 12 by a distance Δ 86.

Accordingly, in some examples, the waveguide structure 32 does not comprise the first substantially square outwardly extending portion 50 and the second substantially square outwardly extending portion 54.

In examples, the first substantially square outwardly extending portion 50 can be considered a raised portion in the three-dimensional hollow structure. For example, the first substantially square outwardly extending portion 50 can be considered an outwardly extending portion and/or raised portion in the positive x direction according to the associated axes in the FIGS. See, for example, FIG. 1A.

Similarly, in examples, the second substantially square outwardly extending portion 54 can be considered a lowered portion in the three-dimensional hollow structure. For example, the second substantially square outwardly extending portion 54 can be considered an outwardly extending portion and/or lowered portion in the negative x direction according to the associated axes in the FIGS. See, for example, FIG. 1B.

In examples, the first and second substantially square outwardly extending portions 50, 54 can be considered outwardly extending as they extend away from a central portion of the apparatus 10/waveguide structure 32.

The dimensions of the first and second substantially square outwardly extending portions 50, 54 can be considered to be substantially the same as they are configured to be the same within a tolerance, for example to within manufacturing accuracy.

The first and second substantially square outwardly extending portions 50, 54 can be considered to be located substantially opposite each other as they are located in substantially the same location on opposing surfaces of the waveguide structure 32 and/or apparatus 10.

For example, the first and second substantially square outwardly extending portions 50, 54 can have substantially the same z and y coordinates with different x coordinates according to the associated axes in the FIGS.

For example, the center 58 of the first and second substantially square outwardly extending portions 50, 54 can have substantially the same z and y coordinates with different x coordinates, according to the associated axes in the FIGS., and have substantially the same side lengths L_{E}.

A center line of a waveguide port can be considered a line along the centre of the waveguide port.

With regard to the first waveguide port 12, a center line can be considered to be a central line through the waveguide port with respect to the z direction in the associated axes in the FIGS.

With regard to the second and third waveguide ports 18, 24 a center line can be considered a central line through the waveguide port with respect to the y direction in the associated axes in the FIGS.

The second and third waveguide ports 18, 24 can share a common center line 60.

By way of example, reference is made to the example of FIG. 5.

FIG. 5 shows a plan view of the apparatus 10 in the example of FIG. 1A. The view shown in the example of FIG. 5 is of the upper surface 52 of the apparatus 10. Accordingly, the first substantially square outwardly extending portion 50 can be seen in the example of FIG. 5.

In the example of FIG. 5, the center line 60 of the second and third waveguide ports 18, 24 and the center line 62 of the first waveguide port 12 are shown.

It can be seen in the example of FIG. 5 that the center 58 of the first substantially square outwardly extending portion 50 (and the second substantially square outwardly extending portion 54 located substantially opposite the first substantially square outwardly extending portion 50) is located on a center line 60 of the second and third waveguide ports 18, 24 and is offset from a center line 62 of the first waveguide port 12 by a distance Δ.

In the illustrated examples, the first and second outwardly extending portions 50, 54 have rounded corners. However, in some examples, the first and second outwardly extending portions 50, 54 do not have rounded corners.

The side length L_{E} of the first (and second) outwardly extending portion 50 is also shown in the example of FIG. 5.

In some examples, the side length L_{E} of the first and second outwardly extending portions 50, 54 can be configured based, at least in part, on the wavelength(s) that the apparatus 10 is configured to operate with.

In some examples, the side length L_{E} of the first and second substantially square outwardly extending portions 50, 54 is approximately λ/4, wherein λ is the free space wavelength at the center of the frequency band at which the apparatus 10 is configured to operate and is in millimeters.

In examples, the center 58 of the first and second outwardly extending portions 50, 54 can be offset from the center line 62 of the first waveguide port 12 by any suitable amount.

In some examples, the distance Δ is less than λ/4, wherein λ is the free space wavelength at the center of the frequency band at which the apparatus 10 is configured to operate and is in millimeters. In some examples, the distance Δ is between λ/6 and λ/8.

The amount that the first and second outwardly extending portions 50, 54 extend and/or protrude outwards can be configured based, at least in part, on the height of the third waveguide port 24.

In some examples, the third waveguide port 24 is substantially rectangular and has a height H_{C} and a distance, Hₑ, between the first and second substantially square outwardly extending portions 50, 54 is approximately 1.2 times H_{C}.

The height, Hₑ, between the first and second substantially square outwardly extending portions 50, 54 can be considered the height of the volume created between the first and second substantially square outwardly extending portions 50, 54 and/or the extent of the volume created between the first and second substantially square outwardly extending portions 50, 54 in the x direction according to the associated axes in the FIGS.

By way of example, reference is made to the example of FIG. 6.

FIG. 6 shows a side view of the apparatus shown in the example of FIG. 1A. In the example of FIG. 6 the distance between the first and second substantially square outwardly extending portions Hₑ and the height H_{C} of the third waveguide port 24 are indicated.

In some examples, the third waveguide port 24 is substantially rectangular and has a height H_{C} and a distance, Hₑ, between the first and second substantially square outwardly extending portions 50, 54 is approximately 1.2 times H_{C}.

In examples, the first and second substantially square outwardly extending portions 50, 54 can be considered a square shaped short circuit arranged throughout (vertically and horizontally) the common RF port. In examples, the apparatus 10 keeps symmetry over the two orthogonal polarizations to get perfect cross polarization values.

The operation mode can be described as an energy equalizer as it is able to compensate the impedance matching of, for example, the vertical polarization, the impedance matching of, for example, the horizontal polarization and at the same time, it blocks any angular rotation of each linear polarization towards its cross component.

In examples, the operation principle of this two sides short circuit is interconnected with the geometric definitions L_{E} as the square side (length equalizer), the height of the equalizer Hₑ and the height of the common port H_{C} having a relation of about Hₑ≈1.2*H_{c} (20% more) for appropriate operation.

FIGS. 7A to 7D show the RF properties of the first and second outwardly extending portions 50, 54. In the examples of FIGS. 7A to 7D, the first polarisation state 16 is vertical polarisation and the second polarisation state 22 is horizontal polarisation.

FIGS. 7A to 7D show the simulation of the transmission and the suppression of the E-field at 12.7 GHz for vertical and horizontal polarizations.

The scales to the right of FIGS. 7A to 7D relate to the arrows indicating the E-field properties.

FIG. 7A shows suppression of E-field propagation at 12.7 GHz for vertical polarisation.

FIG. 7B shows transmission of E-field propagation at 12.7 GHz for vertical polarisation.

FIG. 7C shows suppression of E-field propagation at 12.7 GHz for horizontal polarisation.

FIG. 7D shows suppression of E-field propagation at 12.7 GHz for horizontal polarisation.

The simulations shown in the examples of FIGS. 7A to 7D are depicted at the same phase value when the polarisation division is accomplished.

As can be seen from the examples of FIGS. 7A and 7B, the vertical polarization is running from the common port (FIG. 7A) and is blocked by the equalizer when it tries to go to the horizontal waveguide (illustrated by the vector fields). On the other part (FIG. 7B), this polarization is transmitted toward the rectangular waveguide operating in vertical polarization. The disclosed equalizer filters the undesired polarization using the previous dimensions (the cross-polarization field components are annulled in phase opposition).

In terms of horizontal polarization (FIGS. 7C and 7D), the same operation principle is shown for the horizontal polarisation. The illustrated examples show extremely low values on cross polarization avoiding any angular rotation.

In examples there is provided an Orthomode Transducer 66, OMT, comprising an apparatus 10 as described herein.

In examples, there is provided an antenna system comprising an apparatus 10 as described herein and/or an OMT 66 as described herein.

Examples of the disclosure provide for robustness against manufacturing process of an apparatus 10 as described herein, and/or a waveguide junction 84 comprising an apparatus 10 as described herein, and/or an OMT 66 comprising an apparatus 10 as described herein.

In examples, an OMT 66 can be assembled using two layers. The assembling procedure of the two layers can cause a deterioration in the RF performance because of the layer's misalignment as shown in the example of FIG. 8A.

FIG. 8A shows a perspective view of an example of an OMT 66 comprising an apparatus 10 as described herein. In the illustrated example, the OMT 66 is assembled using two layers which can be misaligned as indicated by the arrows pointing in opposite directions in FIG. 8A.

In the illustrated example, the first waveguide port 12 leads to and/or comprises a waveguide comprising a substantially 90 degree bend and/or turn and/or elbow, and the second waveguide port 18 leads to and/or comprises a waveguide comprising two 90 degree bends and/or turns and/or elbows such that the end of the waveguides end pointing in substantially the same direction.

Examples of the disclosure provide for robustness the assembling procedure because the polarization division and/or equalization are carried out with the features described herein which provide for decreasing the required dimensions of the apparatus 10/waveguide junction 64/OMT 66. Thus, the examples of the disclosure are much less affected by a wrong assembling process compared to other solutions.

This is illustrated by FIGS. 8B and 8C which show the simulated Return Loss variation in the 21.2 GHz-23.6 GHz frequency band adding a misalignment of ±0.1λ (corresponding to left and right shifts), where A is the free space wavelength at the center of the frequency band. This scenrio fits with the regular worst case for the standard machining procedure.

FIG. 8B shows the return loss variation for vertical polarisation without (line 78) and with (lines 80a and 80b) horizontal misalignment of ±0.1λ.

With regard to the vertical polarization return loss, examples of the disclosure keep an excellent matching level as the deterioration is only 5 dB, from 40 dB of the ideal alignment case to 35 dB of the worst case.

FIG. 8C shows the return loss variation for horizontal polarisation without (line 78) and with (lines 80a and 80b) horizontal misalignment of ±0.1λ.

With regard to the horizontal polarization, the simulated RF worsening is less than 5 dB over the frequency band and the OMT impedance matching performance remains more than 30 dB.

Traditional orthomode transducer solutions in the same frequency band exhibit a lowering return loss value of around 15 dB due to such manufacturing process issues. Consequently, return loss figures of only 15 dB are not compliant for, for example, use in future dual carrier (DC) outdoor units (ODUs) for new wireless Backhaul applications.

As previously noted, examples of the disclosure provide for a compact apparatus 10, and/or waveguide junction 64, and/or OMT 66. See, for example, FIG. 9.

FIG. 9 shows a perspective view of an OMT 66 comprising an apparatus 10 as described herein.

In examples, the OMT 66 is configured to convey RF signals to a DC ODU by the two rectangular waveguides inputs ensuring the transmission of two orthogonal polarizations. As difference with one carrier ODUs, the compact and flat OMT 66 places the two inputs/outputs RF ports at the same contact surface without separating the two ports into two different contact surfaces.

In examples, the third waveguide port 24 feeds directly the square or circular waveguide antenna feed, optimizing at best the RF performance.

As examples of the disclosure separate each orthogonal polarization by an apparatus 10 disclosed herein, examples of the disclosure are very compact with a dimension around 2.5λ (width)×1.25λ (depth), where A is the free space wavelength, as shown in the example of FIG. 9.

In examples, the distance between the two single polarization ports is strongly reduced (as the core part of the OMT 66 is around only 2.5λ width) showing that examples of the disclosure will correspond correctly with the more demanding inter axis distance required by future DC ODUs. Additionally, as dimensions have been diminished, there is ample unoccupied space to attain the other key parameter that others OMTs cannot: symmetry.

FIGS. 10A and 10B show simulation of the E-Field distribution for vertical polarisation (FIG. 10A) and horizontal polarisation (FIG. 10B). Perfect transmission of each polarized electromagnetic wave is demonstrated regarding the energy propagation.

Examples of the disclosure can be used in microwave antennas for the backhaul applications and more exactly related with the next generation of dual carrier ODUs that will replace the single carrier ODUs.

Examples of the disclosure propose a new compact, symmetric and vertical orthomode transducer 66 to combine/divide and to convert the two orthogonal polarizations from the ODU to the single port (operating in dual polarization mode) of the microwave antenna feed, in the TE₁₁ circular/square waveguide.

Examples of the disclosure can be designed to operate in each of the commercial frequency bands, from 6 GHz up to 80 GHz, there is no frequency band that can limit its use.

Examples of the disclosure exhibit a high rejection between the two polarizations (inter port isolation), excellent return loss values, very low transmission losses and high isolation between each linear polarization port and the common RF port (cross polarization discrimination).

Examples of the disclosure provide for a flat and compact orthomode transducer feeding network, intended to feed the dual polarisation (for example vertical and horizontal) primary source of a, for example, parabolic antenna, through a circular/square waveguide operating in both linear polarisation. Examples of the disclosure provide an orthomode transducer 66 that is specially designed for the next generation of Dual Carrier Backhaul ODUs.

Examples of the disclosure, provide for separation and combining of two linear and orthogonal propagation modes TE10. From the ODU side with two separate rectangular waveguides where each one is representative of one polarization toward the antenna side, where they are combined in only one RF common port operating the two modes at the same time through an RF architecture as described herein.

Examples of the disclosure allow the manufacturing by classical machining of the apparatus 10, and/or waveguide junction 64, and/or OMT 66 as described herein in two distinct layers before assembling them together.

FIGS. 11A and 11B shows the simple and easy manufacturing solution that reduces the function cost (machining speed, layers to be assembled, removed risk of RF no compliance due to bad alignment, sealing . . . and so on).

FIGS. 11A and 11B show perspective views of first and second layers 82, 84 that can be combined to form an apparatus 10 and/or waveguide junction 64, and/or OMT 66 as described herein.

FIG. 11C shows the layers 82, 84 when the have been assembled.

Examples of the disclosure are advantageous and/or provide technical benefits.

For example, examples of the disclosure provide high RF performance: low return loss (30 dB return loss over 20% bandwidth), high inter-port isolation and cross polarisation discrimination (>40 dB), and/or low insertion loss (<0.5 dB).

For example, examples of the disclosure provide for a highly compact OMT.

For example, examples of the disclosure provide for ease of machining and robustness to manufacturing misalignment.

For example, examples of the disclosure provide for two input/output ports at a single contact surface. The use of a single contact surface can allow for using only two layers.

Where a structural feature has been described, it may be replaced by means for performing one or more of the functions of the structural feature whether that function or those functions are explicitly or implicitly described.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1. An apparatus comprising:
a first waveguide port configured to support first signals having a first polarisation state;
a second waveguide port configured to support second signals having a second polarisation state orthogonal to the first polarisation state;
a third waveguide port configured to support combined signals comprising a first signal component having the first polarisation state and a second signal component having the second polarisation state;
a waveguide structure, disposed between the first waveguide port, the second waveguide port and the third waveguide port, configured to:
split a combined signal received via the third waveguide port into first and second signal components and to provide the first signal component to the first waveguide port and the second signal component to the second waveguide port,
and/or
combine a first signal received via the first waveguide port and a second signal received via the second waveguide port into a combined signal and to provide the combined signal to the third waveguide port;
wherein an end portion of the first waveguide port, adjacent the waveguide structure, comprises, at a first side, a first curved portion having a first radius of curvature, r1, and, at a second side, a second curved portion having a second, different radius of curvature, r2.

2. An apparatus as claimed in claim 1, wherein r₁ is greater than r₂.

3. An apparatus as claimed in claim 1 where
$$\frac{λ}{8} < \frac{{r}_{1}}{{r}_{2}} < \frac{λ}{4} ,$$
wherein λ is the free space wavelength at the center of the frequency band.

4. An apparatus as claimed in claim 1, wherein the first waveguide port is substantially rectangular and has a height t₁, wherein the waveguide structure comprises a portion having a height t₂ adjacent the end portion of the first waveguide portion, wherein t₁ is greater than t₂.

5. An apparatus as claimed in claim 1, wherein the waveguide structure comprises a first curved portion having a radius of curvature r₃ and a second curved portion having a radius of curvature r₃, the first curved portion located above the second curved portion and the first and second curved portions adjacent the first curved portion of the first waveguide port.

6. An apparatus as claimed in claim 5, wherein r₃ is approximately 20% more than r₁.

7. An apparatus as claimed in claim 5, when dependent on claim 4, wherein the first curved portion has a height greater than t₁ and the second curved portion has a height greater than t₁.

8. An apparatus as claimed in claim 7, wherein the first and second curved portions are separated by a height of t₂.

9. An apparatus as claimed in claim 1, wherein the waveguide structure comprises a first substantially square outwardly extending portion at an upper surface and a second substantially square outwardly extending portion at a lower surface, wherein the first and second substantially square outwardly extending portions have substantially the same dimensions and are located substantially opposite each other and wherein the center of the first and second substantially square outwardly extending portions is located on a center line of the second and third waveguide ports and is offset from a center line of the first waveguide port by a distance Δ.

10. An apparatus as claimed in claim 9, wherein the side length L_{E} of the first and second substantially square outwardly extending portions is approximately λ/4, wherein λ is the free space wavelength at the center of the frequency band.

11. An apparatus as claimed in claim 9, wherein the distance Δ is less than λ/4, wherein λ is the free space wavelength at the center of the frequency band.

12. An apparatus as claimed in claim 9, wherein the third waveguide port is substantially rectangular and has a height H_{C} and a distance, Hₑ, between the first and second substantially square outwardly extending portions is approximately 1.2 times H_{C}.

13. An apparatus as claimed in claim 1, wherein the apparatus comprises a waveguide junction.

14. An Orthomode Transducer, OMT, comprising an apparatus as claimed in claim 1.

15. An antenna system comprising an apparatus and/or an OMT as claimed in claim 14.
